(19) United States
(12) Patent Application Publication
(10) Pub. No.: US 2013/0002827 A1
(43) Pub. Date: Jan. 3, 2013

(54) APPARATUS AND METHOD FOR CAPTURING LIGHT FIELD GEOMETRY USING MULTI-VIEW CAMERA

(75) Inventors: Seung Kyu Lee, Seoul (KR); Do Kyoon Kim, Seongnam-si (KR); Hyun Jung Shim, Seoul (KR)

(73) Assignee: Samsung Electronics Co., LTD., Suwon-si (KR)

(21) Appl. No.: 13/483,435

(22) Filed: May 30, 2012

(30) Foreign Application Priority Data
Jun. 30, 2011 (KR) 10-2011-0064221

(51) Int. Cl. H04N 13/02

(52) U.S. Cl. 348/48; 348/E13.074; 348/E13.015; 348/E13.025; 348/E13.019

(57) ABSTRACT

An apparatus and method for capturing a light field geometry using a multi-view camera that may refine the light field geometry varying depending on light within images acquired from a plurality of cameras with different viewpoints, and may restore a three-dimensional (3D) image.

### CROSS-REFERENCE TO RELATED APPLICATIONS

This application claims the priority benefit of Korean Patent Application No. 10-2011-0064221, filed on Jun. 30, 2011, in the Korean Intellectual Property Office, the disclosure of which is incorporated herein by reference.

### BACKGROUND

1. Field

Example embodiments of the following description relate to a technology that may acquire a geometry based on a light field of a three-dimensional (3D) scene.

2. Description of the Related Art

In a conventional three-dimensional (3D) geometry acquiring scheme, geometry information is acquired from a plurality of color camera sets with different viewpoints, using color information consistency. The conventional 3D geometry acquiring scheme is commonly employed by a stereo matching technology or multi-view stereo (MVS) schemes.

However, the conventional 3D geometry acquiring scheme may reduce the accuracy of an initially acquired geometry, and may be performed only when corresponding color information obtained from multiple viewpoints needs to be consistent during refinement of geometry information. Considering lighting or material information required to obtain more realistic 3D information, it is theoretically impossible to acquire a light field that varies depending on a viewpoint.

### SUMMARY

The foregoing and/or other aspects are achieved by providing an apparatus for capturing a light field geometry using a multi-viewpoint camera, including a camera controller to select positions of a plurality of depth cameras, or positions of a plurality of color cameras, and to calibrate different viewpoints of the depth cameras, or different viewpoints of the color cameras, and a geometry acquirement unit to acquire images from the depth cameras having the calibrated viewpoints or the color cameras having the calibrated viewpoints, and to acquire geometry information from the acquired images.

The camera controller may select the positions of the depth cameras or the positions of the color cameras, based on a restrictive condition.

The camera controller may acquire, as a restrictive condition from a display environment of the acquired images, at least one of a space dimension, an object dimension, a position of an object, a number of cameras, an arrangement of each camera, a viewpoint of each camera, and a parameter of each camera.

The camera controller may select a number of the depth cameras or the positions of the depth cameras, or a number of the color cameras or the positions of the color cameras, based on at least one of a calibration accuracy of the acquired images, a geometry accuracy of the acquired images, a color similarity of the acquired images, and an object coverage of each of the depth cameras or each of the color cameras.

The apparatus may further include a geometry refinement unit to reflect the acquired geometry information on the acquired images, to acquire color set information for each pixel within each of the images where the geometry information is reflected, to change pixel values within a few of the images that are different in color set information from the other images, and to refine the geometry information.

The foregoing and/or other aspects are also achieved by providing an apparatus for capturing a light field geometry using a multi-viewpoint camera, including a geometry acquirement unit to acquire intrinsic images from a plurality of cameras, and to acquire geometry information from the acquired intrinsic images, the plurality of cameras having different viewpoints that are calibrated, and an image restoration unit to restore the intrinsic images based on the acquired geometry information.

The geometry acquirement unit may acquire intrinsic images that are based on an International Organization for Standardization-Bidirectional Reflectance Distribution Function (ISO-BRDF) scheme.

The image restoration unit may delete an intrinsic image including a reflection area from the intrinsic images based on the geometry information, and may restore the intrinsic images using intrinsic images in which a change in color information is below a threshold, among the remaining intrinsic images.

The foregoing and/or other aspects are also achieved by providing an apparatus for capturing a light field geometry using a multi-viewpoint camera, including a geometry acquirement unit to acquire images from a plurality of cameras, and to acquire geometry information from the acquired images, the plurality of cameras having different viewpoints that are calibrated, a geometry refinement unit to refine the acquired geometry information using a feature similarity among the acquired images, and an image restoration unit to restore the acquired images based on the refined geometry information.

The geometry refinement unit may reflect the acquired images on the acquired geometry information, and may refine the acquired geometry information by a comparison of a color pattern similarity among the reflected images.

The geometry refinement unit may reflect the acquired images on the acquired geometry information, and may refine the acquired geometry information by a comparison of a structure similarity among the reflected images.

The geometry refinement unit may compare the structure similarity among the reflected images, using a mutual information-related coefficient.

The geometry refinement unit may extract edges from each of the reflected images, and may compare the structure similarity among the reflected images, based on a comparison among the extracted edges.

The geometry refinement unit may reflect the acquired images on the acquired geometry information, and may refine the acquired geometry information by a comparison of a color similarity among the reflected images.

The geometry refinement unit may correct pieces of color information within one of the reflected images, depending on whether each of the pieces of color information is identical to neighboring peripheral color information within a threshold, and may refine the acquired geometry information.

The image restoration unit may compute a marginal probability of each pixel within the acquired images from the refined geometry information, using a belief propagation algorithm, and may restore the acquired images based on the computed marginal probability.

The foregoing and/or other aspects are also achieved by providing a method for capturing a light field geometry using a multi-viewpoint camera, including acquiring images from a plurality of cameras, the plurality of cameras having different viewpoints that are calibrated, acquiring geometry information from the acquired images, refining the acquired geometry information using a feature similarity among the acquired images, and restoring the acquired images based on the refined geometry information.

Additional aspects, features, and/or advantages of example embodiments will be set forth in part in the description which follows and, in part, will be apparent from the description, or may be learned by practice of the disclosure.

According to example embodiments, it is possible to easily acquire a three-dimensional (3D) geometry of a light field within images that are acquired from a plurality of cameras by calibrating different viewpoints of the cameras through selection of positions of the cameras.

Additionally, according to example embodiments, it is possible to easily acquire a 3D geometry using intrinsic images based on the ISO-BRDF scheme.

Furthermore, according to example embodiments, it is possible to refine geometry information using a feature similarity of images acquired from a plurality of cameras with calibrated viewpoints, and to efficiently restore the images based on the refined geometry information.

Moreover, according to example embodiments, it is possible to refine geometry information based on a color pattern similarity among images, a structure similarity among images, or a color similarity among images, and to easily acquire a light field geometry varying depending on a viewpoint of a camera.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a block diagram of a configuration of an apparatus for capturing a light field geometry using a multi-view camera according to an example embodiment;

FIG. 2 illustrates a diagram of an example of acquiring a restrictive condition from a display environment of images according to example embodiments;

FIG. 3 illustrates a block diagram of a configuration of an apparatus for capturing a light field geometry using a multi-view camera according to another example embodiment;

FIG. 4 illustrates a block diagram of a configuration of an apparatus for capturing a light field geometry using a multi-view camera according to still another example embodiment;

FIG. 5 illustrates a diagram of an example of refining geometry information using a color pattern similarity between images according to example embodiments;

FIG. 6 illustrates a diagram of an example of refining geometry information using a structure similarity between images according to example embodiments;

FIG. 7 illustrates a diagram of an example of refining geometry information using a color similarity between images according to example embodiments;

FIG. 8 illustrates a diagram of an example of restoring images based on geometry information according to example embodiments; and

FIG. 9 illustrates a flowchart of a method for capturing a light field geometry using a multi-view camera according to example embodiments.

### DETAILED DESCRIPTION

Reference will now be made in detail to example embodiments, examples of which are illustrated in the accompanying drawings, wherein like reference numerals refer to like elements throughout. Example embodiments are described below to explain the present disclosure by referring to the figures.

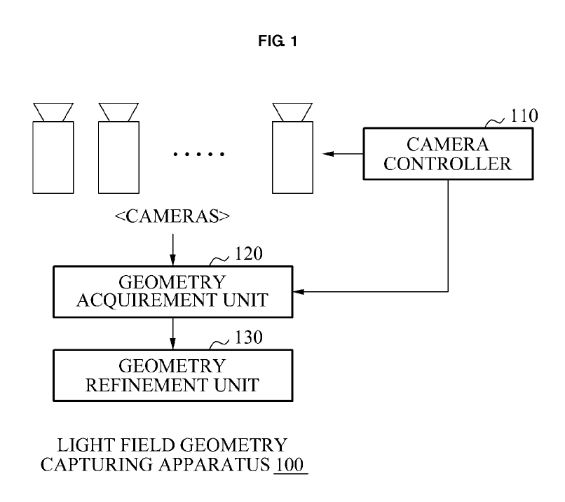

FIG. 1 illustrates a block diagram of a configuration of an apparatus for capturing a light field geometry using a multi-view camera according to an example embodiment. Hereinafter, an apparatus for capturing a light field geometry using a multi-view camera may be referred to as a “light field geometry capturing apparatus.”

Referring to FIG. 1, a light field geometry capturing apparatus 100 may include a camera controller 110, a geometry acquirement unit 120, and a geometry refinement unit 130.

A scheme of restoring geometry information using images acquired from a plurality of color cameras and a plurality of depth cameras that are positioned at different viewpoints may enable acquiring of geometry information with a greater accuracy using three-dimension (3D) depth information, unlike conventional schemes using only color cameras.

In the light field geometry capturing apparatus 100, variables such as the number of color cameras, the number of depth cameras, the relative position of cameras, and the direction of cameras, for example, may have an influence on the accuracy of acquired geometry information.

Accordingly, the camera controller 110 may select positions of a plurality of depth cameras or positions of a plurality of color cameras, and may calibrate different viewpoints of the depth cameras or different viewpoints of the color cameras. Specifically, the camera controller 110 may select each of the positions of the depth cameras or each of the positions of the color cameras based on the viewpoints, and may increase the accuracy of geometry information of images that are acquired from the depth cameras or the color cameras at the selected positions.

As an example, the camera controller 110 may select the positions of the depth cameras or the positions of the color cameras, based on a restrictive condition. For example, the camera controller 110 may acquire, as a restrictive condition from a display environment of the acquired images, at least one of a space dimension, an object dimension, a position of an object, a number of cameras, an arrangement of each camera, a viewpoint of each camera, and a parameter of each camera.

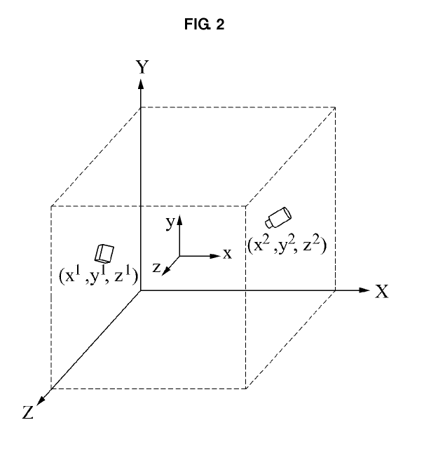

FIG. 2 illustrates a diagram of an example of acquiring a restrictive condition from a display environment of images according to example embodiments.

Referring to FIG. 2, when images are reflected on an X, Y, Z coordinate system, a space dimension may have a value of “0” to a maximum value of each of X, Y, and Z (0≦X≦Xₘₐₓ, 0≦Y≦Yₘₐₓ, 0≦Z≦Zₘₐₓ).

Additionally, an object dimension may have a value of “0” to a maximum value of x, y, z coordinate values, based on the center of an object within the space dimension (0≦x≦xₘₐₓ, 0≦y≦ₘₐₓ, 0≦z≦zₘₐₓ).

The camera controller 110 may acquire, as a restrictive condition, at least one of a position of an object (for example, a position (x¹, y¹, z¹), (x², y², z²) . . . of the object), a number of cameras (for example, a number N_{cc} of color cameras, or a number N_{d} of depth cameras), an arrangement of cameras, a viewpoint of each camera, and a parameter of each camera, and may select positions of the cameras based on the acquired restrictive condition.

As another example, the camera controller 110 may select the number of the depth cameras or the positions of the depth cameras, or the number of the color cameras or the positions of the color cameras, based on at least one of a calibration accuracy of the acquired images, a geometry accuracy of the acquired images, a color similarity of the acquired images, and an object coverage of each of the depth cameras or each of the color cameras. The camera controller 110 may measure the calibration accuracy, the geometry accuracy, the color similarity, and the object coverage using the acquired images, parameters of the cameras, and the like, and may acquire the measured calibration accuracy, the measured geometry accuracy, the measured color similarity, and the measured object coverage.

For example, as a distance between two color cameras increases, a ray intersection of the two color cameras and a 3D structure may increase in accuracy. Conversely, as the distance between the two color cameras decreases, data calibration may be more effectively performed due to better image matching.

As another example, since accurate evaluation is possible as a number of pieces of sample color information for each pixel in an image is increased, higher accuracy may be obtained according to an increase in the number of color cameras. However, the size of a camera set may be increased, and costs may also be increased.

Accordingly, the camera controller 110 may select an optimal position of a depth camera and a color camera, based on at least one of the calibration accuracy, the geometry accuracy, the color similarity, and the object coverage. Here, the depth camera and color camera may be used to acquire geometry information. Subsequently, the camera controller 110 may determine a total number of cameras based on a geometry restoration accuracy acquired at the selected position.

The geometry acquirement unit 120 may acquire images from the depth cameras or the color cameras that have the calibrated viewpoints, and may acquire geometry information from the acquired images. For example, the geometry acquirement unit 120 may acquire point clouds from the acquired images, may generate a point cloud set by calibrating the acquired point clouds, and may initially acquire the geometry information from the generated point cloud set using a mesh modeling scheme.

Since optical noise, mechanical noise, algorithm noise, and the like may occur in the depth cameras among the cameras, the initially acquired geometry information may contain a large number of errors.

To solve the errors, the geometry refinement unit 130 may reflect the acquired geometry information on the acquired images, and may obtain color set information for each pixel within each of the images where the acquired geometry information is reflected. The geometry refinement unit 130 may change pixel values within a few of the images that are different in color set information from the other images, and may refine the geometry information. Specifically, the geometry refinement unit 130 may refine the geometry information by replacing color information of a unique pixel value with color information of a greater number of pixel values, so that different color information may be made to be consistent with each other.

Based on the fact that different light information is observed from different viewpoints, a scheme of using stereo matching or color information consistency based on color information obtained from different viewpoints may be limited.

To easily complement the scheme, intrinsic images may be acquired and geometry information may be acquired using the acquired intrinsic images in the same manner as in FIG. 1, under the assumption that all input images are based on an International Organization for Standardization-Bidirectional Reflectance Distribution Function (ISO-BRDF).

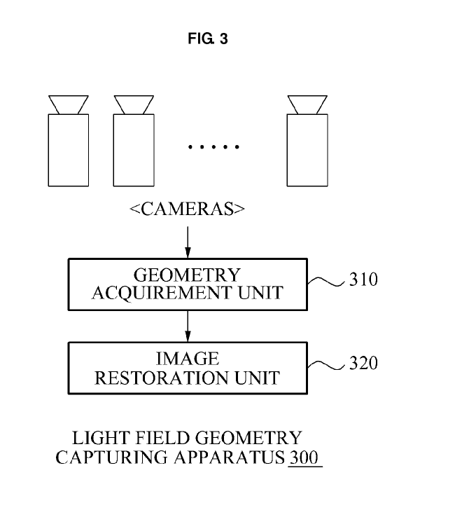

FIG. 3 illustrates a block diagram of a configuration of a light field geometry capturing apparatus according to another example embodiment.

Referring to FIG. 3, a light field geometry capturing apparatus 300 may include a geometry acquirement unit 310, and an image restoration unit 320.

The geometry acquirement unit 310 may acquire intrinsic images from a plurality of cameras with different viewpoints that are calibrated, and may acquire geometry information from the acquired intrinsic images. For example, the geometry acquirement unit 310 may acquire intrinsic images that are based on the ISO-BRDF.

The image restoration unit 320 may restore the intrinsic images based on the acquired geometry information. For example, the image restoration unit 320 may delete an intrinsic image having a reflection area from the intrinsic images based on the geometry information, and may restore the intrinsic image, using intrinsic images in which a change in color information is below a threshold, from the remaining non-deleted intrinsic images. The threshold may be set to a value suitable for restoring the deleted intrinsic image from the remaining non-deleted intrinsic images. When a larger number of intrinsic images are acquired, the image restoration unit 320 may determine whether the intrinsic images include a reflection area.

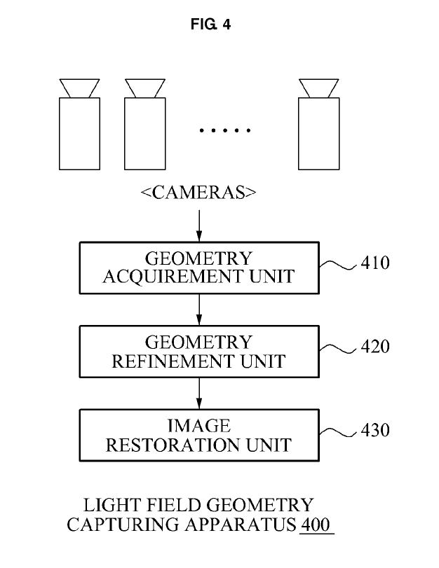

FIG. 4 illustrates a block diagram of a configuration of a light field geometry capturing apparatus according to still another example embodiment.

Referring to FIG. 4, a light field geometry capturing apparatus 400 may include a geometry acquirement unit 410, a geometry refinement unit 420, and an image restoration unit 430.

The geometry acquirement unit 410 may acquire images from a plurality of cameras having different viewpoints. The plurality of cameras may include a plurality of color cameras, and a plurality of depth cameras. For example, the geometry acquirement unit 410 may calibrate the different viewpoints of the cameras by selecting positions of the cameras, and may acquire the images from the cameras having the calibrated viewpoints.

The geometry acquirement unit 410 may acquire geometry information from the acquired images.

For example, the geometry acquirement unit 410 may acquire point clouds from the acquired images, and may generate a point cloud set by calibrating the acquired point clouds, so that the geometry information may be acquired from the generated point cloud set using a mesh modeling scheme.

The geometry refinement unit 420 may refine the acquired geometry information, based on a feature similarity among the acquired images. The feature similarity may include, for example, a color pattern similarity among the acquired images, a structure similarity among the acquired images, and a color similarity of each of the acquired images.

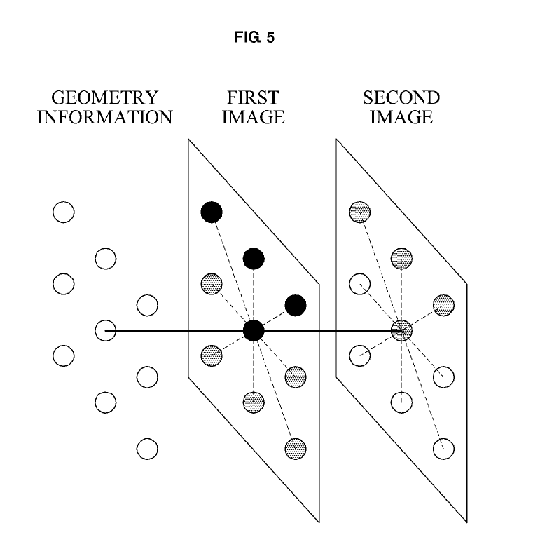

Hereinafter, an example in which geometry information is linearly changed will be described with reference to FIG. 5.

FIG. 5 illustrates a diagram of an example of refining geometry information using a color pattern similarity between images.

Referring to FIG. 5, the geometry refinement unit 420 may reflect a first image and a second image on geometry information, and may refine the geometry information by a comparison of a color pattern similarity between the first image and the second image. Here, the first image, the second image, and the geometry information may be acquired by the geometry acquirement unit 410. In other words, the geometry refinement unit 420 may optimize a pixel geometry based on a color similarity and a pattern similarity of a normalized local region.

For example, the geometry refinement unit 420 may compare a color similarity and a pattern similarity among pixels of the first image and pixels of the second image, to refine the geometry information. In this example, the pixels of the first image may correspond to the pixels of the second image. The color similarity may refer to a similarity of colors, such as black, gray, and white, and the pattern similarity may refer to a similarity of a pattern of circles. As shown in FIG. 5, pixels in an upper portion of the first image are indicated by black circles, and corresponding pixels in an upper portion of the second image are indicated by gray circles. Additionally, pixels in a lower portion of the first image are indicated by gray circles, and corresponding pixels in a lower portion of the second image are indicated by white circles. Accordingly, the geometry refinement unit 420 may determine that the pixels have the color pattern similarity, despite a difference in color value, and may match geometry information between the first image and the second image.

In other words, when color values or patterns of two corresponding pixels are not exactly matched to each other, but are changed in the same level within a reference range, even when, the geometry refinement unit 420 may determine that the two pixels may have similar colors and patterns.

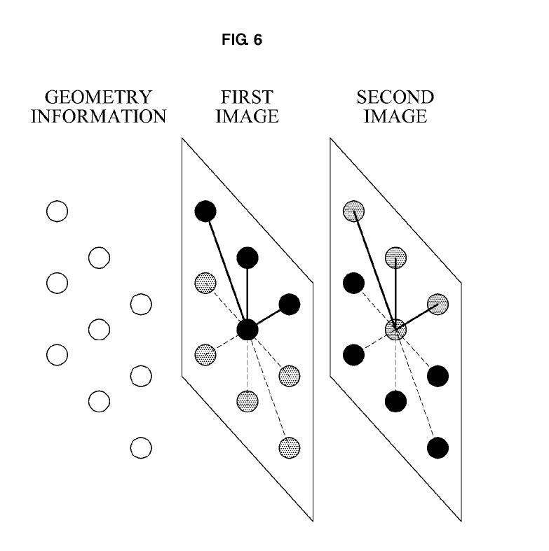

Hereinafter, an example in which geometry information is non-linearly changed will be described with reference to FIG. 6.

FIG. 6 illustrates a diagram of an example of refining geometry information using a structure similarity between images.

Referring to FIG. 6, the geometry refinement unit 420 may refine the acquired geometry information by a comparison of a structure similarity between the first image and the second image that are reflected on the acquired geometry information.

As an example, the geometry refinement unit 420 may compare the structure similarity between the first image and the second image, using a mutual information-related coefficient. Specifically, when the first image and the second image have mutually dependent regular structures, despite the structures not being exactly consistent with each other, the geometry refinement unit 420 may determine that the first image and the second image may have structure similarity, and may match the geometry information between the first image and the second image.

As another example, the geometry refinement unit 420 may extract edges from each of the first image and the second image, and may compare the structure similarity between the first image and the second image by a comparison among the extracted edges. In this example, when the edges extracted from the first image and the second image are similar, the geometry refinement unit 420 may determine that the first image and the second image may have structure similarity, and may match the geometry information between the first image and the second image.

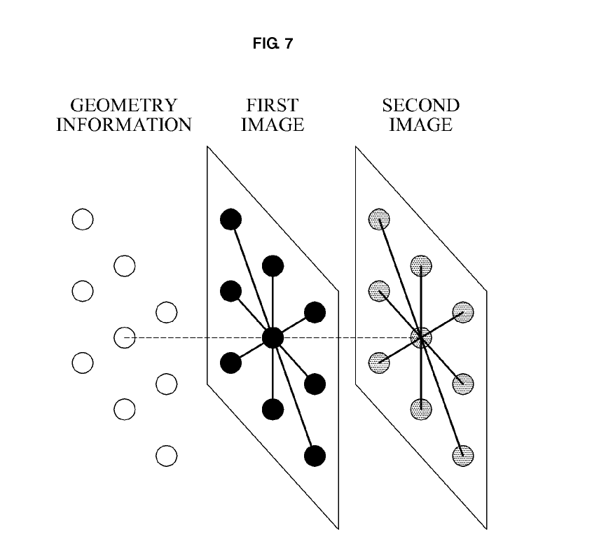

Hereinafter, an example in which geometry information is not matched as a result of the matching in the examples of FIGS. 5 and 6 will be described with reference to FIG. 7.

FIG. 7 illustrates a diagram of an example of refining geometry information using a color similarity between images.

Referring to FIG. 7, the geometry refinement unit 420 may reflect the first image and the second image on the acquired geometry information, and may refine the acquired geometry information by a comparison of a color similarity between the first image and the second image.

For example, the geometry refinement unit 420 may correct pieces of color information, depending on whether each of the pieces of color information is identical to neighboring peripheral color information within a threshold, and may refine the acquired geometry information. In this example, the pieces of color information may be acquired from the first image, and the pieces of color information and the peripheral color information may be indicated by black circles. When first color information is identical to neighboring peripheral color information positioned in sides, an upper portion, or a lower portion of the first color information within a threshold, the geometry refinement unit 420 may maintain the first color information to be the same, or may replace the first color information by the peripheral color information.

The image restoration unit 430 may restore the acquired images based on the refined geometry information.

Feature similarity schemes described above with reference to FIGS. 5 through 7 may be respectively interpreted using observation values used to obtain 3D geometry information. Specifically, the observation values may refer to observation sets observed to obtain a peripheral possibility of a current pixel of geometry information that is currently graphically-modeled. For example, an observation value of a single 3D pixel may be represented by a relationship between observation values of other peripheral pixels. Accordingly, a change in geometry information of a single 3D pixel may have an influence on geometry information of neighboring pixels.

The image restoration unit 430 may represent a relationship between neighboring 3D pixels using a joint probability, and may perform graphic modeling.

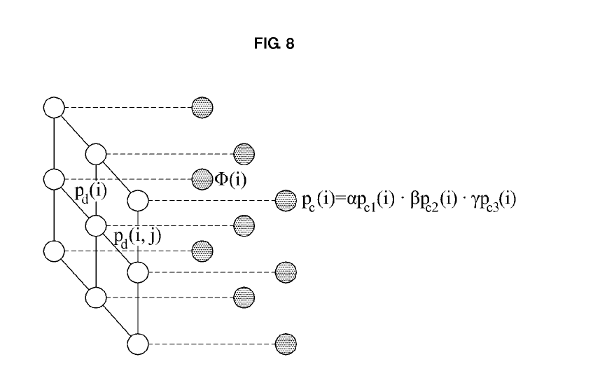

FIG. 8 illustrates a diagram of an example of restoring images based on geometry information according to example embodiments.

Referring to FIG. 8, the image restoration unit 430 of FIG. 4 may select a most suitable similarity P_{c} from among color pattern similarity P_{c1}, structure similarity P_{c2}, and color similarity P_{c3}, and may restore the acquired images using the geometry information refined by the selected similarity. Specifically, the image restoration unit 430 may change constants of α, β, and γ respectively described in front of the similarity P_{c1}, the structure similarity P_{c2}, and the color similarity P_{c3}, and may select the most suitable similarity P_{c}.

For example, the image restoration unit 430 may compute a marginal probability of each pixel within the acquired images from the refined geometry information, using a belief propagation algorithm, and may restore the acquired images based on the computed marginal probability. In other words, the image restoration unit 430 may restore the acquired images based on a relationship between neighboring pixels.

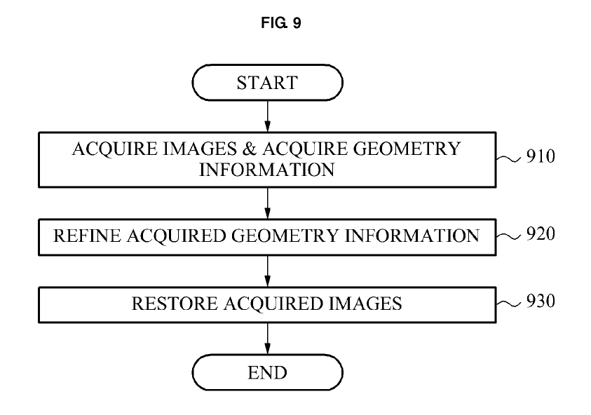

FIG. 9 illustrates a flowchart of a method for capturing a light field geometry using a multi-view camera according to example embodiments.

Referring to FIG. 9, in operation 910, a light field geometry capturing apparatus may acquire images from a plurality of cameras with different viewpoints. Specifically, the light field geometry capturing apparatus may select positions of the cameras, may calibrate the different viewpoints of the cameras, and may acquire the images from the cameras having the calibrated viewpoints. The plurality of cameras may include, for example, a plurality of color cameras, and a plurality of depth cameras.

Additionally, in operation 910, the light field geometry capturing apparatus may acquire geometry information from the acquired images. For example, the light field geometry capturing apparatus may acquire point clouds from the acquired images, may generate a point cloud set by calibrating the acquired point clouds, and may initially acquire the geometry information from the generated point cloud set using a mesh modeling scheme.

Since optical noise, mechanical noise, algorithm noise, and the like may occur in the depth cameras among the cameras, the initially acquired geometry information may contain a large number of errors.

In operation 920, the light field geometry capturing apparatus may refine the acquired geometry information using a feature similarity between the acquired images.

As an example, the light field geometry capturing apparatus may reflect the acquired images on the acquired geometry information, and may refine the acquired geometry information by a comparison of a color pattern similarity between the reflected images.

As another example, the light field geometry capturing apparatus may reflect the acquired images on the acquired geometry information, and may refine the acquired geometry information by a comparison of a structure similarity between the reflected images. The light field geometry capturing apparatus may compare the structure similarity between the reflected images using a mutual information-related coefficient. Additionally, the light field geometry capturing apparatus may extract edges from each of the reflected images, and may compare the structure similarity between the reflected images by a comparison among the extracted edges.

As another example, the light field geometry capturing apparatus may reflect the acquired images on the acquired geometry information, and may refine the acquired geometry information by a comparison of a color similarity between the reflected images. The light field geometry capturing apparatus may correct pieces of color information within one of the reflected images, depending on whether each of the pieces of color information is identical to neighboring peripheral color information within a threshold, and may refine the acquired geometry information.

In operation 930, the light field geometry capturing apparatus may restore the acquired images based on the refined geometry information. For example, the light field geometry capturing apparatus may compute a marginal probability of each pixel within the acquired images from the refined geometry information, using a belief propagation algorithm, and may restore the acquired images based on the computed marginal probability.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. An apparatus for capturing a light field geometry using a multi-viewpoint camera, the apparatus comprising:
a camera controller to select positions of a plurality of depth cameras, or positions of a plurality of color cameras, and to calibrate different viewpoints of the depth cameras, or different viewpoints of the color cameras; and
a geometry acquirement unit to acquire images from the depth cameras having the calibrated viewpoints or the color cameras having the calibrated viewpoints, and to acquire geometry information from the acquired images.

2. The apparatus of claim 1, wherein the camera controller selects the positions of the depth cameras or the positions of the color cameras, based on a restrictive condition.

3. The apparatus of claim 1, wherein the camera controller acquires, as a restrictive condition from a display environment of the acquired images, at least one of a space dimension, an object dimension, a position of an object, a number of cameras, an arrangement of each camera, a viewpoint of each camera, and a parameter of each camera.

4. The apparatus of claim 1, wherein the camera controller selects a number of the depth cameras or the positions of the depth cameras, or a number of the color cameras or the positions of the color cameras, based on at least one of a calibration accuracy of the acquired images, a geometry accuracy of the acquired images, a color similarity of the acquired images, and an object coverage of each of the depth cameras or each of the color cameras.

5. The apparatus of claim 1, further comprising:
a geometry refinement unit to reflect the acquired geometry information on the acquired images, to acquire color set information for each pixel within each of the images where the geometry information is reflected, to change pixel values within a few of the images that are different in color set information from the other images, and to refine the geometry information.

6. An apparatus for capturing a light field geometry using a multi-viewpoint camera, the apparatus comprising:
a geometry acquirement unit to acquire intrinsic images from a plurality of cameras, and to acquire geometry information from the acquired intrinsic images, the plurality of cameras having different viewpoints that are calibrated; and
an image restoration unit to restore the intrinsic images based on the acquired geometry information.

7. The apparatus of claim 6, wherein the geometry acquirement unit acquires intrinsic images that are based on an International Organization for Standardization-Bidirectional Reflectance Distribution Function (ISO-BRDF) scheme.

8. The apparatus of claim 6, wherein the image restoration unit deletes an intrinsic image having a reflection area from the intrinsic images based on the geometry information, and restores the intrinsic images using intrinsic images in which a change in color information is below a threshold, among the remaining intrinsic images.

9. An apparatus for capturing a light field geometry using a multi-viewpoint camera, the apparatus comprising:
a geometry acquirement unit to acquire images from a plurality of cameras, and to acquire geometry information from the acquired images, the plurality of cameras having different viewpoints that are calibrated;
a geometry refinement unit to refine the acquired geometry information using a feature similarity among the acquired images; and
an image restoration unit to restore the acquired images based on the refined geometry information.

10. The apparatus of claim 9, wherein the geometry refinement unit reflects the acquired images on the acquired geometry information, and refines the acquired geometry information by a comparison of a color pattern similarity among the reflected images.

11. The apparatus of claim 9, wherein the geometry refinement unit reflects the acquired images on the acquired geometry information, and refines the acquired geometry information by a comparison of a structure similarity among the reflected images.

12. The apparatus of claim 11, wherein the geometry refinement unit compares the structure similarity among the reflected images, using a mutual information-related coefficient.

13. The apparatus of claim 11, wherein the geometry refinement unit extracts edges from each of the reflected images, and compares the structure similarity among the reflected images, based on a comparison among the extracted edges.

14. The apparatus of claim 9, wherein the geometry refinement unit reflects the acquired images on the acquired geometry information, and refines the acquired geometry information by a comparison of a color similarity among the reflected images.

15. The apparatus of claim 14, wherein the geometry refinement unit corrects pieces of color information within one of the reflected images, depending on whether each of the pieces of color information is identical to neighboring peripheral color information within a threshold, and refines the acquired geometry information.

16. The apparatus of claim 9, wherein the image restoration unit computes a marginal probability of each pixel within the acquired images from the refined geometry information, using a belief propagation algorithm, and restores the acquired images based on the computed marginal probability.

17. A method for capturing a light field geometry using a multi-viewpoint camera, the method comprising:
acquiring images from a plurality of cameras, the plurality of cameras having different viewpoints;
acquiring geometry information from the acquired images;
refining the acquired geometry information using a feature similarity among the acquired images; and
restoring the acquired images based on the refined geometry information.

18. The method of claim 17, wherein the acquiring of the images comprises:
selecting positions of the cameras, and calibrating the different viewpoints of the cameras; and
acquiring the images from the cameras having the calibrated viewpoints.

19. The method of claim 17, wherein the refining of the acquired geometry information comprises:
reflecting the acquired images on the acquired geometry information; and
refining the acquired geometry information by a comparison of a color pattern similarity among the reflected images.

20. The method of claim 17, wherein the refining of the acquired geometry information comprises:
reflecting the acquired images on the acquired geometry information;
comparing a structure similarity among the reflected images, using a mutual information-related coefficient; and
refining the acquired geometry information based on a result of the comparing.

21. The method of claim 17, wherein the refining of the acquired geometry information comprises:
reflecting the acquired images on the acquired geometry information;
extracting edges from each of the reflected images;
comparing a structure similarity among the reflected images, based on a comparison among the extracted edges; and
refining the acquired geometry information based on a result of the comparing.

22. The method of claim 17, wherein the refining of the acquired geometry information comprises:
reflecting the acquired images on the acquired geometry information;
determining whether each of pieces of color information within one of the reflected images is identical to neighboring peripheral color information within a threshold; and
correcting the pieces of color information based on a result of the determining, and refining the acquired geometry information.

23. The method of claim 17, wherein the restoring of the acquired images comprises:
computing a marginal probability of each pixel within the acquired images from the refined geometry information, using a belief propagation algorithm; and
restoring the acquired images based on the computed marginal probability.

24. A non-transitory computer readable medium storing computer readable instructions that control at least one processor to implement the method of claim 17.

25. An apparatus for capturing a light field geometry using a multi-viewpoint camera, the apparatus comprising:
a camera controller to select positions of a plurality of depth cameras, and to calibrate different viewpoints of the depth cameras; and
a geometry acquirement unit to acquire images from the depth cameras having the calibrated viewpoints, and to acquire geometry information from the acquired images.
